(19) United States
(12) Patent Application Publication
(10) Pub. No.: US 2016/0320275 A1
(43) Pub. Date: Nov. 3, 2016

(54) METHOD FOR DETERMINING A CONCENTRATION OF METAL IMPURITIES CONTAMINATING A SILICON PRODUCT

(71) Applicant: HEMLOCK SEMICONDUCTOR CORPORATION, Hemlock, MI (US)

(72) Inventors: Douglas H. Kreszowski, Saginaw, MI (US); Carl W. Puehl, Midland, MI (US); Dale Franklin Workman, Saginaw, MI (US)

(21) Appl. No.: 15/108,973

(22) PCT Filed: Dec. 31, 2014
(86) PCT No.: PCT/US2014/072946

§ 371 Date: Jun. 29, 2016

Related U.S. Application Data
(60) Provisional application No. 61/923,328, filed on Jan. 3, 2014.

(51) Int. Cl. G01N 1/40; C01B 33/02

(52) U.S. Cl. CPC G01N 1/4044; C01B 33/02

(57) ABSTRACT

A method determines a concentration of metal impurities contaminating a silicon product. The method comprises obtaining a test sample of the silicon product with the metal impurities disposed thereon. The test sample is placed within a first vessel. A first acid solution is added to the first vessel containing the test sample. The test sample is submerged into the first acid solution to produce a mixed solution comprising the first acid solution, the metal impurities, and digested silicon. The undigested silicon is sep crated from the mixed solution. The mixed solution is analyzed to determine the concentration of metal impurities contaminating the silicon product.

Disclosed herein is a method for determining a concentration of metal impurities contaminating a silicon product.

Silicon products are used in various applications. In some applications, it is desirable to produce silicon products with a high purity, e.g., purity exceeding metallurgical grade silicon. For example, production of high-density integrated circuits requires wafers of monocrystalline silicon of high purity. Metal impurities on the silicon product, such as copper, gold, iron, cobalt, nickel, chromium, tantalum, zinc, tungsten, titanium, magnesium, molybdenum, and aluminum can be harmful to the production of such integrated circuits.

In an effort to produce silicon products with high purity, contact of the silicon product with other materials is generally avoided to prevent contamination of the silicon product. For example, contact of the silicon product with metal containing materials is avoided to prevent the metal from being transferred to the silicon product thereby contaminating the silicon product. Metal contamination of the silicon product can severely limit the end use of the silicon product. As such, contact of the silicon product with metal containing material is typically avoided.

However, depending on the process, contact of the silicon product with metal containing materials is virtually unavoidable. For example, when the silicon product is to be crushed, the silicon product is typically subjected to crushing by a roll crusher. Generally, portions of the roll crusher that contact the silicon product are made from a cemented tungsten carbide with a cobalt binder because this material is generally less limiting on the end uses of the silicon product as compared to other metals, such as nickel. However, certain end uses of the silicon product are sensitive to the presence of tungsten and/or cobalt. Therefore, it is often necessary to quantify the contamination of the silicon product by tungsten and/or cobalt before the silicon product can be used for its intended end use.

Current testing methods have proven to be unreliable for quantifying the contamination of the silicon product by various metals, such as tungsten and cobalt. For example, Vapor Phase Decomposition (VPD) can accomplish quantifying the contamination of silicon products. However, VPD is not capable of removing all of the metal contamination from the surface of the silicon product, especially when the metal contamination comprises tungsten and/or cobalt. Therefore, there remains a need to develop a more sensitive testing method to quantify contamination of the silicon product to include tungsten and cobalt.

Disclosed, in various embodiments, are methods for determining the concentration of metal impurities contaminating a silicon product.

A method determines a concentration of metal impurities contaminating a silicon product. The method comprises obtaining a test sample of the silicon product with the metal impurities disposed thereon. The test sample is placed within a first vessel. A first acid solution is added to the first vessel containing the test sample. The test sample is submerged into the first acid solution to produce a mixed solution comprising the first acid solution, the metal impurities, and digested silicon. The undigested silicon is separated from the mixed solution. The mixed solution is analyzed to determine the concentration of metal impurities contaminating the silicon product.

A method determines a concentration of tungsten carbide contaminating a silicon product. The method comprises obtaining a test sample of the silicon product with the tungsten carbide disposed thereon. The test sample is placed within a first vessel. A first acid solution is added to the first vessel containing the test sample. The test sample is submerged into the first acid solution to produce a mixed solution comprising the first acid solution, tungsten from the tungsten carbide, and digested silicon. The undigested silicon is separated from the mixed solution. The mixed solution is analyzed to determine the concentration of tungsten and cobalt thereby determining the concentration of tungsten carbide contaminating the silicon product.

These and other features and characteristics are more particularly described below.

The present application relates to a method for determining a concentration of metal impurities contaminating a silicon product. Quantifying the concentration of metal impurities associated with silicon products is important for determining possible end uses for the silicon product.

Generally, the silicon product comprises semiconductor grade silicon. By “semiconductor grade silicon,” it is meant a material comprising at least 99 percent by weight silicon. As such, the inventive method is especially useful for removing metal impurities on the surface of semiconductor grade silicon for analyzing the concentration of the metal impurities contaminating the silicon product. However, the inventive method is not limited to removing metal impurities from semiconductor grade silicon. Rather, the inventive method can generally be used on any composition comprising at least 95 percent by weight of elemental silicon.

An example of the silicon product is polycrystalline silicon. Polycrystalline silicon serves as a seed material in the production of monocrystalline or multicrystalline silicon, which is used in the production of solar cells for photovoltaic cells. It is desirable to produce monocrystalline or multicrystalline silicon with high purity, e.g., purity exceeding metallurgical grade silicon. Therefore, when the silicon product is polycrystalline silicon for producing the monocrystalline or multicrystalline silicon, it is desirable to produce polycrystalline silicon with high purity to minimize contamination contributed to the monocrystalline or multicrystalline silicon by the polycrystalline silicon. As such, the contamination of the silicon product is typically determined prior to using the silicon product as the seed material in subsequent processes.

Typically, when the silicon product is characterized as high purity, an impurity content of the silicon product is less than or equal to 1,000 parts per billion atomic (ppba). The generic definition for ppba, as used herein, is the number of atoms of the impurity per billion atoms of the main component. It is to be appreciated that ppba, parts per million atomic (ppma), and parts per trillion atomic (ppta) are useful units in semiconductor or other high purity applications where the amount of impurities is low. For the specific case of measuring metal impurities, it is the number of atoms of the metal impurity per atoms of silicon. The 1,000 ppba is near the typical high limit for surface impurities encountered with “unclean” semiconductor silicon and the reaction chemistry described herein can extract metal impurities at higher concentrations than 1,000 ppba. With minor modifications in the measuring processes of the Inductively Coupled Plasma Mass Spectrometry (ICP-MS), the inventive method can be used for less pure silicon processes such as that used with metallurgical grade silicon.

The impurity content is a measurement of the concentration of impurities contaminating the silicon product. The impurity content generally refers to the total amount of all impurities present in the silicon product unless otherwise noted. It is to be appreciated that within the class of silicon products having high purity, additional distinctions can be made based on sequentially lower impurity contents. While the above threshold for characterizing the silicon product as high purity provides an upper limit for the impurity content, the silicon product can have a substantially lower impurity content than the threshold set forth above.

Impurities, as the term is generally used herein, are defined as elements or compounds the presence of which is undesirable in the silicon product. Known impurities of concern when working with silicon products include gold, iron, nickel, copper, chromium, magnesium, aluminum, sodium, zinc, manganese, molybdenum, titanium, cobalt, and tungsten. However, it is to be appreciated that metal impurities tested for using the inventive method are typically only limited by the capabilities of the instruments used. For example, ICP-MS instruments are capable of measuring most elements within the periodic table of elements. As such, the metal impurities tested for can be selected from Group I, Group II, transitional metals, and lanthanide metals of the periodic table of elements. Typical elements monitored from Group I, Group II, transition metals, and lanthanide metals of the periodic table of elements can be selected from the group of gold, iron, nickel, copper, chromium, magnesium, aluminum, sodium, zinc, manganese, molybdenum, titanium, cobalt, and tungsten, and combinations thereof. More typically, the metal impurity tested for is tungsten. Even more typically, the metal impurity tested for is tungsten extracted from compounds of tungsten carbide. It is to be appreciated that the physical shape of the silicon product and the physical shape of the test sample is not critical to the present invention and the silicon product or test sample can be in the form of rods, wafers, chunks, and particles.

The method of determining the concentration of metal impurities contaminating a silicon product has many uses. For example, when establishing processing conditions for the silicon product and developing machinery for producing and handling the silicon product, it is helpful to quantify the concentration of the metal impurities to possible improve the materials used within the machinery. Additionally, determining the concentration of the metal impurities contaminating the silicon product also determines possible end uses for the silicon product. It has been discovered that current testing methods are insufficient to accurately determine the extent of the contamination from metal impurities. For example, current test methods fail to accurately determine the concentration of tungsten and cobalt present on the silicon product. However, the inventive method of determining the concentration of metal impurities disclosed herein addresses this issue.

The method includes obtaining a test sample of the silicon product with the metal impurities disposed thereon. The form of the silicon product is not critical to the method. For example, the silicon product can be further defined as flowable recharge silicon and/or polycrystalline silicon.

The method also includes placing the test sample within a first vessel. The type of vessel is not critical, but the vessel must be able to hold acids without degrading and not be a source of metal impurity contamination. The test sample should include enough of the silicon product to be representative of the silicon product that is being produced and be of substantial mass to provide a measurable signal on the appropriate metals testing instrumentation, which in this case is typically ICP-MS. For example, the test sample is about 1 to 500, for example about 1 to 105, and for example about 95 to 105 grams of the silicon product with the metal impurities disposed thereon.

The method can optionally include preparing a first acid solution. However, it is to be appreciated that the acid solution can be provided thereby eliminating the need to perform a step of preparing the first acid solution. The first acid solution comprises HCl, HNO₃, and HF. In one embodiment, the first acid solution has a molar ratio of about 150-300 HCl to about 2-20 HNO₃ to about 1 HF. For example, the first acid solution has a molar ratio of about 233 HCl to about 14 HNO₃ to about 1 HF.

The method includes adding the first acid solution to the first vessel containing the test sample. As a result of adding the first acid solution to the first vessel, the first acid solution contacts the test sample. Contacting the test sample with the first acid solution can be further described as submerging the test sample into the first acid solution. For example, the method can include adding a sufficient volume of the first acid solution to submerge the test sample within the first vessel. Submerging the test sample in the first acid solution ensures that the entire surface of the test sample is in contact with the first acid solution. As such, any metal impurities on the surface of the test sample of the silicon product will be in contact with the first acid solution. A volume of the first acid solution added to the first vessel can be about 30 to about 110, for example about 50 to about 100, and for example about 100 milliliters. However, it is to be appreciated that the method is scalable depending on the size of the test sample being tested. As such, the volume of the first acid solution can be increased depending on the size of the test sample.

Contact of the first acid solution with the test sample allows for the dissolution of the metal impurities on the test sample of the silicon product. For example, when the metal impurity includes cemented tungsten carbide, the first acid solution enables dissolution of the cemented tungsten carbide into measurable elements of tungsten and cobalt.

The contact of the first acid solution with the test sample results in a mixed solution comprising the first acid, the metal impurities, and digested silicon. Typically, the contact time of the first acid solution with the test sample is greater than 18 hours. However, the contact time could vary depending on how long it takes to digest the tungsten carbide on the surface of the test sample.

The method also includes separating the undigested silicon from the mixed solution. Separating the undigested silicon from the mix solution leaves the mixed solution for additional analysis without interference from the undigested silicon.

The method includes analyzing the mixed solution to determine the concentration of metal impurities contaminating the silicon product. It is to be appreciated that analyzing the mixed solution can be accomplished in various ways. For example, the mixed solution can be dried to evaporate any remaining liquid thereby concentrating the metal impurities. As such, drying the mixed solution can result in the production of a solid residue comprising the metal impurities. After the solid residue is produced, the solid residue, which comprises the metal impurities, can be reconstituted with a reconstituting solution. When employed, the reconstituting solution typically comprises nitric acid, and deionized water. The reconstituted solid residue within the reconstituting solution can be tested to determine the concentration of the metal impurities present therein. Alternatively, testing of the reconstituted solid residue for metal impurities can be accomplished by using an inductively coupled plasma mass spectrometer. Furthermore, testing of the reconstituted solid residue for metal impurities can be accomplished by using a graphite furnace atomic absorption process.

The method can include separating the mixed solution from the undigested silicon is further defined as adding a second acid solution to the mixed solution to dissolve the undigested silicon. It is to be appreciated that the second acid solution typically comprises HNO3 and HF. When the second acid solution is employed, the second acid solution can have a molar ratio of about 1.5 to 2.5 HNO₃ to of from about 1 HF.

It is to be appreciated that the first acid solution, as well as other items used during the test method, can be a source that introduces metal impurities to the test sample of the silicon product. For example, metal impurities can be contained in the first acid solution. As such, the method can include determining a concentration of metal impurities contaminating the first acid solution. Typically, the determination of the concentration of metal impurities contaminating the first acid solution is accomplished by preparing and analyzing an acid blank. Notably, the test sample is never introduced into the acid blank. Therefore, any metals impurities within the acid blank most likely originated from background baseline contamination, such as from containers, instrument, the first acid solution, and/or the second acid solution.

The acid black is prepared by adding a volume of the first acid solution into an empty vessel. The acid blank is then analyzed in a similar manner as the mixed solution, which is described above, to determine the concentration of the metal impurities within the acid blank. Analyzing the acid blank can be accomplished in a similar manner as analyzing the mixed solution. For example, analyzing the acid blank can comprise drying the first acid solution to produce a blank solid residue comprising the metal impurities contaminating the first acid solution. At that point, the blank solid residue can be reconstituted using the reconstituting solution and testing the reconstituted blank solid residue to determine the concentration of the metal impurities contaminating the first acid solution. Once known, the concentration of the metal impurities contaminating the acid blank can be subtracted from the concentration of the metal impurities contaminating the test sample of the silicon product to provide a corrected concentration of the metal impurities contaminating the test sample of the silicon product.

When employed, the acid blanks can be used to more accurately determine the concentration of the metal impurities contaminating the test sample in parts per billion atomic (ppba) because the use of the acid blanks eliminates most of the background contamination from the calculation thereby leaving the concentration of the metal impurities actual contaminating the test sample.

In addition to the use of acid blanks, a spike solution can be used to monitor a stability of the inventive method. More specifically, the spike solution, which has a known concentration of the metal impurities, can be added to an additional acid blank to determine the accuracy of the method. Once the spike solution is added to the additional acid blank, the additional acid blank is subjected to the method steps to determine a concentration of the metal impurities in the additional acid blank. The concentration of metal impurities in the additional acid blank can be corrected by subtracting the concentration of metal impurities found in the acid blank to eliminate background contamination. Once corrected, the concentration of metal impurities of the additional acid blank can be compared to the known concentrations of the spike solution itself to determine the accuracy of the method. It is to be appreciated that there are other possible procedures for determining the accuracy of the method.

In one embodiment, the method is used to determine a concentration of tungsten carbide contaminating a silicon product. Because the silicon product is likely to come into contact with tungsten carbide, the contamination from the tungsten carbide, typically in the form of tungsten and cobalt, should be quantified. More specifically, use of tungsten carbide is commonplace in industry machinery applications used within facilities producing the silicon product. The tungsten in the tungsten carbide is present in a metal matrix composite, with tungsten carbide as the aggregate and cobalt as the matrix. Typically, the tungsten carbide has a molar ratio of 7-9 (tungsten moles/cobalt moles). Because the silicon product is likely to be exposed to tungsten carbide, the concentration of tungsten in the silicon product should be calculated. The method of determining the concentration of tungsten carbide contaminating the silicon product is similar to the method described above. As such, the method of determining the concentration of tungsten carbide contaminating the silicon product includes all of the alternative steps described above.

Typically, the method to determine the concentration of tungsten carbide contaminating the silicon product includes obtaining a test sample of the silicon product with the tungsten carbide disposed thereon; placing the test sample within a first vessel; adding a first acid solution to the first vessel containing the test sample; submerging the test sample into the first acid solution to produce a mixed solution comprising the first acid solution, tungsten and cobalt from the tungsten carbide, and digested silicon; separating the undigested silicon from the mixed solution; and analyzing the mixed solution to determine a concentration of tungsten and cobalt thereby determining the concentration of tungsten carbide contaminating the silicon product.

The method of determining the concentration of metal impurities contaminating the silicon product has many uses. For example, based on the determined concentration of metal impurities contaminating the silicon test sample, low contaminant materials can be selected to form various components of handling and processing equipment of the silicon product. Additionally, possible end uses of the silicon product can be identified based on the concentration of the metal impurities contaminating the silicon test sample.

The following example are merely illustrative of the device disclosed herein and are not intended to limit the scope hereof.

A comparative example was performed to compare the results from two different methods for testing the concentration of the metal impurities contaminating the silicon product. More specifically, ten different test samples were tested using a Vapor Phase Decomposition (VPD) test, as disclosed in U.S. Pat. No. 5,851,303, and the inventive method disclosed herein. The test samples were specifically tested with a focus on determining the concentration of tungsten and cobalt because these metal impurities result from exposure of the silicon product to tungsten carbide with a cobalt binder. In this comparative example, the cemented tungsten carbide had an expected molar ratio of 7-9 (tungsten molar/cobalt molar). Acid blanks were used for both testing methods to minimize the impact of background contamination not associated with the silicon product or its test samples. The concentrations of the metal impurities were measured on a Perkin-Elmer ICP-MS. The results of the comparative example are provided below in Table 1.

TABLE 1
Comparative Example between VPD Test and the Inventive Method

| | Cobalt Value | | Tungsten Value | |
|---|---|---|---|---|
| | (ppbw) | | (ppbw) | |
| | VPD | Inventive | | Inventive |
| Test sample | Method | Method | VPD Method | Method |
| Silicon Test sample 1 | 1.989 | 2.714 | 1.722 | 19.427 |
| Silicon Test sample 2 | 2.298 | 2.518 | 2.147 | 17.672 |
| Silicon Test sample 3 | 2.219 | 2.818 | 2.352 | 19.628 |
| Silicon Test sample 4 | 1.796 | 2.918 | 2.085 | 20.418 |
| Silicon Test sample 5 | 2.126 | 2.865 | 2.365 | 20.318 |
| Silicon Test sample 6 | 2.411 | 3.411 | 2.838 | 24.058 |
| Silicon Test sample 7 | 2.037 | 2.292 | 1.688 | 15.053 |
| Silicon Test sample 8 | 2.124 | 2.945 | 1.803 | 19.029 |
| Silicon Test sample 9 | 2.159 | 2.444 | 1.663 | 16.961 |
| Silicon Test sample 10 | 2.511 | 3.199 | 1.617 | 21.006 |
| Average Value (ppbw): | 2.167 | 2.812 | 2.028 | 19.357 |

As shown in the table, the inventive method detected much higher concentrations of tungsten as compared to the VPD test. The inventive method also detected high concentrations of cobalt. To verify the accuracy of the two different tested methods, the molar ratio of tungsten and cobalt was calculated for each test method. As indicated above, the range of the expected molar ratio of the cemented tungsten carbide is between 7-9. The molar ratio calculated based on the VPD test results was 0.9, which is significantly outside the expected range. The molar ratio calculated based on the inventive method was 6.9, which is much closer to the expected range than the molar ratio of the VPD test.

Based on the results of Table 1, it is believed that the method disclosed herein is better suited to separate tungsten and cobalt from the test sample of the silicon product as compared to the VPD test. Therefore, the concentrations determined using the method disclosed herein more accurately reflect the actual concentrations of tungsten and cobalt contaminating the test sample and is therefore a more accurate testing method as compared to the VPD test.

The methods disclosed herein include at least the following embodiments:

Embodiment 1: A method of determining a concentration of metal impurities contaminating a silicon product, comprising: obtaining a test sample of the silicon product with the metal impurities disposed thereon; placing the test sample within a first vessel; adding a first acid solution to the first vessel containing the test sample; submerging the test sample into the first acid solution to produce a mixed solution comprising the first acid solution, the metal impurities, and digested silicon; separating the undigested silicon from the mixed solution; and analyzing the mixed solution to determine the concentration of metal impurities contaminating the silicon product.

Embodiment 2: A method as set forth in Embodiment 1, wherein analyzing the mixed solution further comprises: drying the mixed solution to produce a solid residue comprising the metal impurities; reconstituting the solid residue comprising the metal impurities with a reconstituting solution; and testing the reconstituted solid residue to determine the concentration of the metal impurities.

Embodiment 3: A method as set forth in claim 2, wherein the reconstituting solution comprises nitric acid, and deionized water.

Embodiment 4: A method as set forth in Embodiment 2, wherein testing the reconstituted solid residue is further defined as testing the reconstituted solid residue for metal impurities using an inductively coupled plasma mass spectrometer.

Embodiment 5: A method as set forth in any of Embodiments 1 to 4, further comprising preparing an acid solution comprising HCL, HNO3, and HF.

Embodiment 6: A method as set forth in Embodiment 5, wherein the acid solution comprises a molar ratio of about 150 to 300 HCl to about 2 to 20 HNO3 to about 1 HF.

Embodiment 7: A method as set forth in any of Embodiments 1 to 6, wherein obtaining a test sample is further defined as obtaining a test sample of from about 1 to 500 grams of the silicon product with the metal impurities disposed thereon.

Embodiment 8: A method as set forth in any of Embodiments 1 to 7, wherein adding the first acid solution is further defined as adding a sufficient volume of the first acid solution to submerge the test sample into the first acid solution.

Embodiment 9: A method as set forth in any of Embodiments 1 to 8, wherein separating the undigested silicon from the mixed solution is further defined as adding a second acid solution to the mixed solution to digest the undigested silicon.

Embodiment 10: A method as set forth in Embodiment 9, further comprising preparing the second acid solution comprising HNO3 and HF.

Embodiment 11: A method as set forth in Embodiment 9, further comprising preparing the second acid solution comprising a molar ratio of about 1.5 to 2.5 HNO3 to about 1 HF.

Embodiment 12: A method as set forth in any of Embodiments 1 to 11, wherein the metal impurities tested for are selected from gold, iron, nickel, copper, chromium, magnesium, aluminum, sodium, zinc, manganese, molybdenum, titanium, cobalt, and tungsten, and combinations thereof.

Embodiment 13: A method as set forth in any of Embodiments 1 to 12, wherein the metal impurity comprises tungsten and cobalt.

Embodiment 14: A method as set forth in any of Embodiments 1 to 13, wherein the metal impurity comprises tungsten.

Embodiment 15: A method of determining a concentration of tungsten carbide contaminating a silicon product, comprising: obtaining a test sample of the silicon product with the tungsten carbide disposed thereon; placing the test sample within a first vessel; adding a first acid solution to the first vessel containing the test sample; submerging the test sample into the first acid solution to produce a mixed solution comprising the first acid solution, tungsten from the tungsten carbide, and digested silicon; separating the undigested silicon from the mixed solution; and analyzing the mixed solution to determine a concentration of tungsten and cobalt thereby determining the concentration of tungsten carbide contaminating the silicon product.

While the invention has been described with reference to exemplary embodiments, it will be understood by those skilled in the art that various changes can be made and equivalents can be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “+10%” means that the indicated measurement can be from an amount that is minus 10% to an amount that is plus 10% of the stated value. The terms “front”, “back”, “bottom”, and/or “top” are used herein, unless otherwise noted, merely for convenience of description, and are not limited to any one position or spatial orientation. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

All cited patents, patent applications, and other references are incorporated herein by reference in their entirety. However, if a term in the present application contradicts or conflicts with a term in the incorporated reference, the term from the present application takes precedence over the conflicting term from the incorporated reference

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/we claim:

1. A method of determining a concentration of metal impurities contaminating a silicon product, comprising:
obtaining a test sample of the silicon product with the metal impurities disposed thereon;
placing the test sample within a first vessel;
adding a first acid solution to the first vessel containing the test sample;
submerging the test sample into the first acid solution to produce a mixed solution comprising the first acid solution, the metal impurities, and digested silicon;
separating the undigested silicon from the mixed solution; and
analyzing the mixed solution to determine the concentration of metal impurities contaminating the silicon product.

2. A method as set forth in claim 1, wherein analyzing the mixed solution further comprises:
drying the mixed solution to produce a solid residue comprising the metal impurities;
reconstituting the solid residue comprising the metal impurities with a reconstituting solution; and
testing the reconstituted solid residue to determine the concentration of the metal impurities.

3. A method as set forth in claim 2, wherein the reconstituting solution comprises nitric acid, and deionized water.

4. A method as set forth in claim 2, wherein testing the reconstituted solid residue is further defined as testing the reconstituted solid residue for metal impurities using an inductively coupled plasma mass spectrometer.

5. A method as set forth in claim 1, further comprising preparing an acid solution comprising HCL, HNO₃, and HF.

6. A method as set forth in claim 5, wherein the acid solution comprises a molar ratio of about 150 to 300 HCl to about 2 to 20 HNO₃ to about 1 HF.

7. A method as set forth in claim 1, wherein obtaining a test sample is further defined as obtaining a test sample of from about 1 to 500 grams of the silicon product with the metal impurities disposed thereon.

8. A method as set forth in claim 1; wherein adding the first acid solution is further defined as adding a sufficient volume of the first acid solution to submerge the test sample into the first acid solution.

9. A method as set forth in claim 1, wherein separating the undigested silicon from the mixed solution is further defined as adding a second acid solution to the mixed solution to digest the undigested silicon.

10. A method as set forth in claim 9, further comprising preparing the second acid solution comprising HNO₃ and HF.

11. A method as set forth in claim 9, further comprising preparing the second acid solution comprising a molar ratio of about 1.5 to 2.5 HNO₃ to about 1 HF.

12. A method as set forth in claim 1, wherein the metal impurities tested for are selected from gold, iron, nickel, copper, chromium, magnesium, aluminum, sodium, zinc, manganese, molybdenum, titanium, cobalt, and tungsten, and combinations thereof.

13. A method as set forth in claim 1, wherein the metal impurity comprises tungsten and cobalt.

14. A method as set forth in claim 1, wherein the metal impurity comprises tungsten.

15. A method of determining a concentration of tungsten carbide contaminating a silicon product, comprising:
obtaining a test sample of the silicon product with the tungsten carbide disposed thereon;
placing the test sample within a first vessel;
adding a first acid solution to the first vessel containing the test sample;
submerging the test sample into the first acid solution to produce a mixed solution comprising the first acid solution, tungsten from the tungsten carbide, and digested silicon;
separating the undigested silicon from the mixed solution; and
analyzing the mixed solution to determine a concentration of tungsten and cobalt thereby determining the concentration of tungsten carbide contaminating the silicon product.
